(19) United States
(12) Patent Application Publication
(10) Pub. No.: US 2010/0169441 A1
(43) Pub. Date: Jul. 1, 2010

(54) TEXT MESSAGING SYSTEM AND METHOD EMPLOYING PREDICTIVE TEXT ENTRY AND TEXT COMPRESSION AND APPARATUS FOR USE THEREIN

(76) Inventors: Philippe Jonathan Gabriel Lafleur, Ottawa (CA); Julie Josée Lafleur, Ottawa (CA)

Correspondence Address: ADAMS PATENT & TRADEMARK AGENCY, P.O. BOX 11100, STATION H, OTTAWA, ON, K2H 7T8, CA

(21) Appl. No.: 12/377,087

(22) PCT Filed: Aug. 20, 2007
(86) PCT No.: PCT/CA07/01426

§ 371 Date: Feb. 10, 2009

Related U.S. Application Data
(60) Provisional application No. 60/838,867, filed on Aug. 21, 2006.

(51) Int. Cl. G06F 15/16

(52) U.S. Cl. 709/206; 709/247

(57) ABSTRACT

A device (110) used for composing, compressing and transmitting messages by way of a data network (100) comprises means (116) for employing predictive text entry during composition of a message (MSG) and compressing the composed message for transmission. Increased redundancy and improved compression efficiency result from having the predictive text entry program (201) suggest character strings (207) derived from a corpus of messages (204) that serves also as a basis for a statistical model (206) used for compression. A messaging system comprising the composition device (110) and a device for receiving and decompressing the message may comprise a messaging (MSG) hub (108) for decompressing messages (MSG) from the composing device and reformatting them, for example as e-mail messages (E-MSG), before transmitting them to the addressee (112, 113, 114, 115) and, conversely, compressing messages from the addressee using a similar corpus of messages (204) before transmitting them to the composing device (110). Peer-to-peer messaging (MSG′) may be provided between two users using similar devices capable of composing, compressing and transmitting messages (110′), and received and decompressing messages (110″).

### CROSS-REFERENCE TO RELATED APPLICATION

This application claims priority from U.S. patent application No. 60/838,867 filed Aug. 21, 2006, the contents of which are incorporated herein by reference.

This invention relates to text messaging systems and methods employing both predictive text entry and text compression, and to apparatus and messaging devices for use therein.

### BACKGROUND ART

Text messaging on portable devices, such as mobile phones and personal digital assistants (PDAs), has grown rapidly in recent years. These messaging devices are small, and as a result, text entry can be awkward. A variety of existing methods have been used to facilitate text entry, including predictive text entry. When a user is entering text on a device with predictive text entry words and phrases are suggested to the user via the user interface, based upon the words and partial words already entered. The suggested words and phrases are taken from a predictive text entry (PTE) database dedicated to this purpose. As disclosed in U.S. Pat. No. 6,307,548 and U.S. Pat. No. 6,219,731, keyboard disambiguation to facilitate text entry on mobile phones is an example application of predictive text entry.

Text messages can be sent and received over a wide variety of networks. Some of these networks, such as mobile satellite communications networks, are narrowband, typically supporting on the order of tens or hundreds of bytes per minute. When communicating over such networks, compression of the message is desirable.

Given the need for data compression and the presence of PTE databases on many devices, the two concepts have been combined. Thus, WO2004059459 discloses the use of the predictive text entry database, referred to therein as a “language dependent dictionary”, as a static compression dictionary. In U.S. Pat. No. 6,963,587, it is stated that “Dictionary compression schemes may be generally categorized as either static or dynamic. A static dictionary is a predefined dictionary, which is constructed before compression occurs that does not change during the compression process. Static dictionaries are typically either stored in the compressor and decompressor prior to use, or transmitted and stored in memory prior to the start of compression operations.”

Such a static compression scheme is disclosed in WO2004059459, wherein it is stated “When the character combination is present in the language dependent dictionary, a reference to the corresponding address in the language dependent dictionary is saved to an output data block. Character combinations in the input data block that are not present in the language dependent dictionary are stored in the output data block as plain text (character code) without compression.” Because this “language dependent dictionary” is static, the compression ratios that it can achieve are somewhat limited.

A potentially better method for the compression of text messages, known as adaptive dictionary based compression, uses compressor and decompressor dictionaries that are built from messages sent or received. This allows the algorithm (compression and decompression models) to adapt to the language patterns of the user.

Such a method is disclosed in U.S. Pat. No. 6,963,587, wherein it is stated that “in general, a dictionary compression scheme uses a data structure known as a dictionary to store strings of symbols which are found in the input data. The scheme reads in input data and looks for strings of symbols which match those in the dictionary. If a string match is found, a pointer or index to the location of that string in the dictionary is outputted and transmitted instead of the string itself. If the index is smaller than the string it replaces, compression will occur. A decompressor contains a representation of the compressor dictionary so that the original string may be reproduced from the received index. An example of a dictionary compression method is the Lempel-Ziv (LZ77) algorithm. This algorithm operates by replacing character strings which have previously occurred in the file by references to the previous occurrence. This method is successful in files where repeated strings are common”.

U.S. Pat. No. 6,963,587 further states “A dynamic or adaptive dictionary scheme, on the other hand, allows the contents of the dictionary to change as compression occurs. In general, a dynamic dictionary scheme starts out with either no dictionary or a default, predefined dictionary and adds new strings to the dictionary during the compression process. If a string of input data is not found in the dictionary, the string is added to the dictionary in a new position and assigned a new index value. The new string is transmitted to the decompressor so that it can be added to the dictionary of the decompressor. The position of the new string does not have to be transmitted, as the decompressor will recognize that a new string has been received, and will add the string to the decompressor dictionary in the same position in which it was added in the compressor dictionary. In this way, a future occurrence of the string in the input data can be compressed using the updated dictionary. As a result, the dictionaries at the compressor and decompressor are constructed and updated dynamically as compression occurs.”

U.S. Pat. No. 6,963,587 further states “Another well suited method for the compression of text messages is known as adaptive context modeling based compression. Specifically applied to a messaging application, the compressor and decompressor build statistical language context models from messages sent or received. A well known context modeling compression algorithm is “Prediction by Partial Matching” (PPM).”

In an article by S. Rein, C. Gühann and F. H. P. Pitzek entitled “Low-Complexity Compression of Short Messages”, Proceedings of the IEEE Data Compression Conference (DCC'06), 2006 it is stated that “PPM is a lossless data compression scheme, where a single symbol is coded taking its previous symbols into account, which are called the symbol's context. A context model is employed that gives statistical information on a symbol and its context. The encoder uses specific symbols to signal the decoder the current context. The number of context symbols defines the model order and is a basio parameter for the compression rate and the algorithm complexity. The symbol probabilities can be processed by an arithmetic coder, thus achieving superior compression over many widespread compression schemes, as for instance the Ziv-Lempel methods (LZ77, LZ78). However, PPM is computationally more complex”. Such a context model can be made adaptive in much the same way as dictionary based methods. The primary difference is that a statistical context model is being built instead of a compression dictionary.

Whether the compression scheme uses a dictionary or statistical context modeling, the linkage between compressibility and redundancy is evident. The more redundancy present in a message relative to the strings of characters in the dictionary, or the symbols that were used to build the statistical context model, the higher the compression ratio will be.

At a fundamental level, these known compression techniques function by taking advantage of the redundancy of the messages being sent. These methods take the input message as a given. If messages could be made more redundant during composition by the user, while maintaining the message's desired meaning, compression would be facilitated and compression ratios could be higher.

### DISCLOSURE OF INVENTION

The present invention seeks to overcome or at least mitigate the shortcomings of such known messaging systems and methods employing predictive text entry (PTE) and text compression, and of associated apparatus used therein; or at least provide alternatives.

According to one aspect of the present invention, there is provided a text messaging system comprising means for composing, compressing and transmitting text messages and means for receiving and decompressing the compressed text messages, the composing, compressing and transmitting means having means for predictive text entry during composition of a message (MSG) in conjunction with means for compressing the composed message (MSG) and transmitting the compressed message to the receiving and decompressing means via a data network, and the receiving and decompressing means having means for decompressing the message following its receipt after transmission and means for conveying the decompressed message to an addressee of the message, wherein the predictive text entry means (201; 803) is arranged to suggest character strings derived from a messages corpus comprising messages upon which the compressing means and decompressing means base the compression and decompression, respectively.

The conveying means may comprise means for reformatting the decompressed message and forwarding same to a destination device.

The reformatting means may be arranged to reformat the decompressed message as an e-mail message (E-MSG), the destination device then comprising an e-mail server at or from which the e-mail message can be accessed by its addresses, either by downloading it or viewing it without downloading, by means of a suitable access device, such as computer means equipped with either or both of an e-mail program and a browser program. Such downloading may be initiated by the e-mail server or the e-mail program.

The system may comprise a narrowband communications network for example a satellite communications network, and the composing, compressing and transmitting means and the received and decompressing means each be capable of interlacing with said network.

Preferably, the composing, compressing and transmitting means may further comprises means for updating the corpus by adding recent messages, for example recently-sent messages.

The composing, compressing and transmitting means may thither comprise means for receiving messages compressed using a corresponding corpus and means for updating the corpus using recently-received messages. Thus, the corpus may be updated using both sent and received messages.

When the corpus associated with compression is updated, the corresponding corpus associated with decompression may be updated in a similar manner, so that the two corpora contain the same messages.

The means for updating the corpus may be arranged to delete a message whenever a new message has been added.

In preferred embodiments of the invention, the corpus is derived from a message set that, following transmission of at least one sent message, comprises at least one previously-sent message. Prior to the composition and sending of a first message, the corpus may comprise a plurality of predefined messages which are replaced during operation with messages that have actually been sent. The predefined messages may comprise typical messages, i.e. the kind of message a typical user might send, and may be grouped according to a relationship between the user and the recipient, e.g., work, personal.

Additionally or alternatively, the compression means may use a messages corpus at last a section of which is static, comprising exclusively a plurality of predefined message.

The means to receiving and decompressing messages may be operable to receive previously-composed messages addressed to a subscriber, compress the previously-composed messages and forward the compressed previously-composed message via the data network to a receiving and decompressing means for the addressee.

In the context of this patent specification, words are defined as strings between delimiting characters, such as a white space or punctuation. Phrases are strings comprising multiple words as defined above. Suggestions are mined from the corpus using search engine techniques including stemming, phonic, fuzzy and synonym searching.

According to a second aspect of the invention, there is provided a text messaging method using means for composing, compressing and transmitting messages via a data network and means for receiving and decompressing said messages, the method comprising the steps of:

(i) at the composing, compressing and transmitting means, composing a message (MSG) using predictive text entry, compressing the composed message (MSG) and transmitting the compressed message via the data network, and
(ii) at the receiving and decompressing means, decompressing the received message (MSG) and conveying the decompressed message to en addressee of the message,

wherein, during the predictive text entry step, character strings suggested to the person composing the message are derived from a messages corpus upon which were based the steps of compression before transmission and decompression following transmission.

According to a third aspect of the invention, there is provided a text messaging device for use in the system of the second aspect, the text messaging device comprising means for composing and compressing text messages and transmitting the compressed messages via a data network to means for receiving and decompressing the compressed text messages, the composing, compressing and transmitting means having means for predictive text entry during composition of a dressage (MSG) in conjunction with means for compressing the composed message (MSG) and transmitting the compressed message to the receiving and decompressing means via the data network, wherein the predictive text entry means is arranged to suggest character strings derived from a messages corpus comprising messages upon which the compressing means and decompressing means base the compression and decompression, respectively.

According to a fourth aspect of the invention, there is provided a messaging hub for use in the system of the second aspect, the messaging hub means comprising means for composing, compressing and transmitting text messages and means for receiving and decompressing similarly compressed text messages, the composing, compressing and transmitting means having means for predictive text entry during composition of a message (MSG) in conjunction with means for compressing the composed message (MSG) and transmitting the compressed message to the receiving and decompressing means via a data network, and the receiving and decompressing means having means for decompressing the message following its receipt after transmission and means for conveying the decompressed message to an addressee of the message, wherein the predictive text entry means is arranged to suggest character strings derived from a messages corpus comprising messages upon which the compressing means and decompressing means base the compression and decompression, respectively.

The foregoing end other objects, features, aspects and advantages of the present invention will become more apparent from the following detailed description, taken in conjunction with the accompanying drawings, of preferred embodiments of the invention which are described by way of example only.

### BRIEF DESCRIPTION OF DRAWING

In the drawings, identical or corresponding elements in the different Figures have the same reference numeral, with a prime or suffix designating a slight difference.

FIG. 1 illustrates a first embodiment, in which a messaging device (composer) uses an adaptive method of compression to compose a message and sends it via a narrowband network to a messaging hub for forwarding to an e-mail server;

FIG. 2 illustrates messaging software, residing on the messaging device enabling it to perform predictive text entry and adaptive compression;

FIG. 3 illustrates the message flow of the messaging software residing on the messaging device of Figure;

FIGS. 4A and 4B illustrate a Predictive Text Entry (PTE) message composition program residing in the messaging device of FIG. 1;

FIG. 5 illustrates the hub software, residing on the messaging hub of FIG. 1, enabling it to perform adaptive decompression;

FIG. 6 illustrates the message flow of the hub software residing on the messaging hub of FIG. 1;

FIG. 7 illustrates a second embodiment of which the e-mail/Internet device (composer) is used to send a message, via the messaging hub, to the messaging device (addressee), using a static method of compression with several compression models;

FIG. 8 illustrates the hub software, residing on the messaging hub of FIG. 7, enabling it to perform predictive text entry and static method of compression;

FIG. 9 illustrates the messaging software residing on the messaging device of FIG. 7, enabling it to perform the static method of decompression;

FIG. 10 illustrates a third embodiment comprising two messaging devices which exchange via a messaging hub messages composed and received using a static method of compression/decompression; and

FIG. 11 illustrates the hub software residing on the messaging hub of FIG. 10 enabling it to employ the static method of decompression/compression.

### DETAILED DESCRIPTION OF PREFERRED EMBODIMENTS

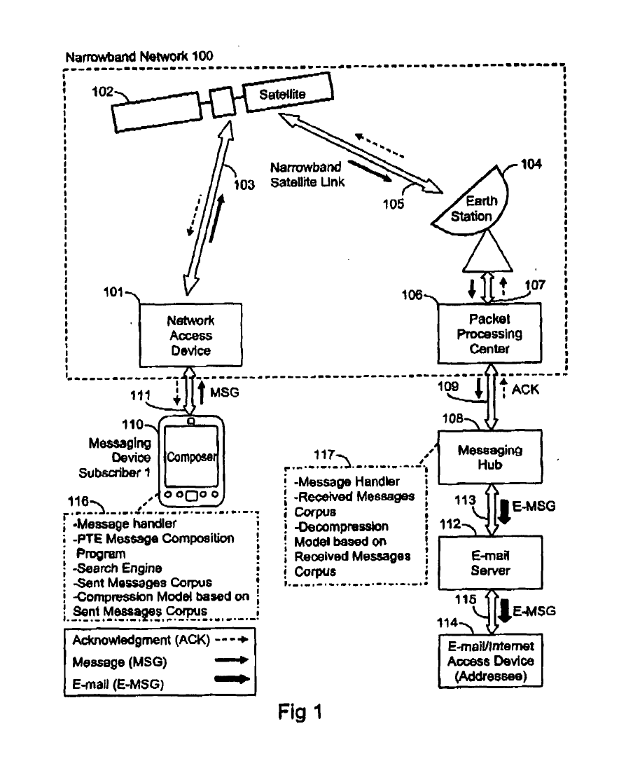

FIG. 1 illustrates part of a communications system for providing messaging service by way of a narrowband network 100 comprising a network access device 101 connected to a satellite 102 by a “return” uplink 103, an earth station 104 connected to the satellite 102 by a “return” downlink 105, and a packet processing centre 106 connected to the earth station 104 by a dedicated link 107.

In such a narrowband satellite communications system, the path from the earth station 104 to the network access device 101 is designated the “forward” path and the path from the network access device 101 to the earth station 104 is designated the “return” path. The forward and return paths are narrowband, typically supporting on the order of tens or hundreds of bytes per minute.

The messaging service also makes use of means for receiving and decompressing such compressed messages comprising, in the embodiment of FIG. 1, a messaging hub 108 and an e-mail server 112. The messaging hub 108 is connected to the packet processing centre 106 of narrowband network 100 by way of network link 109 (or a landline, dedicated link or other means) and to the e-mail server 112 by a network link 113.

Means for composing, compressing and transmitting a message, in the form of a messaging device 110 used by a subscriber 1 is shown connected to the network access device 101 by a link 111, which may be wired or wireless. The e-mail server 112 can be accessed by a message addressee (recipient) using an e-mail/Internet capable device 114, such as a computer or personal digital assistant (PDA), as indicated by link 115. Subscribers are characterized by their use of the messaging device 110 and the network access device 101 as well as having a subscriber ID. The subscriber ID is known by the messaging hub 108 and the packet processing center 106, i.e., each will have a list of subscriber IDs and associated data. External users such as, in this case, the addressee, need not be subscribers.

To send a message MSG, subscriber 1 composes the message MSG using software and data 116 which resides on the messaging device 110. The functional modules of software and data 116 are shown in FIG. 1 to comprise a message handler, a predictive text entry (PTE) message composition program, a search engine, a sent messages corpus and a compression model based on the sent messages corpus, as will be described in detail later.

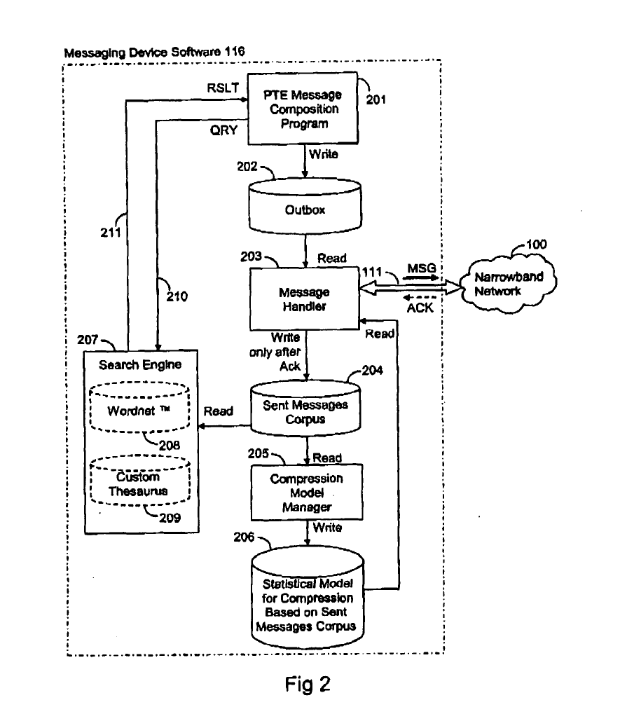

While subscriber 1 is composing the message MSG, the PIE message composition program uses the other modules to formulate suggestions which it displays to subscriber 1 for optional adoption. Once subscriber 1 deems the message MSG to be complete and presses sends or otherwise initiates transmission of the message, the message handler (203 FIG. 2) compresses and formats the message MSG for transmission and the messaging device 110 sends it to the network access device 101 via link 111, typically via a proprietary modem protocol/command set.

The network access device 101 includes a satellite communication modem and antenna system for the transmission and reception of satellite communication signals. These items are well-known to those skilled in this art, so they are not shown or described in detail herein. The network access device 101 formulates and transmits the packets containing the message MSG via the narrowband satellite return uplink 103 to satellite 102 which forwards them via narrowband satellite return downlink 105 to the earth station 104.

The earth station 104 includes an antenna and modem for the transmission and reception of satellite communication signals. Although conceptually similar to the network access device 101, the implementation of the earth station 104 is quite different because it is intended to support many subscribers simultaneously.

The earth station 104 reformats the received packets, typically according to a proprietary protocol, and sends than via dedicated link 107 to the packet processing center 106. The packet processing center 106 reformats the packets and routes them via link 109 to the messaging hub 108 which also supports a plurality of subscribers, including subscriber 1.

As illustrated in FIG. 1, the messaging hub 108 has software and data 117 complementary to that (116) of the messaging device 110. In particular, software and data 117 comprises a message handler, a received messages corpus, and a decompression model based on the received messages corpus, the functioning of which will be described later.

The messaging hub 108 uses software and data 117 to decompress the message MSG received from messaging device 110, reformats it into an e-mail message E-MSG, and then sends the e-mail message E-MSG to the intended addressee's account at e-mail server 112 for subsequent access by the addressee using e-mail/Internet access device 114.

The messaging hub 108 also generates and sends back to messaging device 110 an acknowledgement message ACK which traverses much the same path as the original message MSG, but in reverse. Lower level acknowledgements occur throughout the system but are omitted for simplicity of the description.

It should be noted that the packet processing center 106, the messaging hub 108, the network access device 101 and the messaging device 110 all have message storage capability. This ensures that messages are buffered and not lost should the messaging hub 108 temporarily lose its link 109 with the packet processing center 106 or the messaging device 110 temporarily lose its link 111 with the network access device 101 or network access device 101 temporarily lose its link 103 with satellite 102.

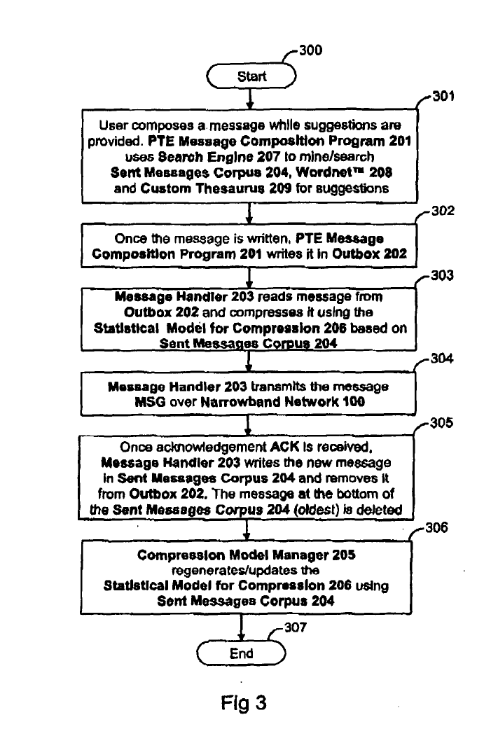

Operation of the software 116 residing upon the messaging device 110 will now be described with reference to FIGS. 2 and 3, the latter summarizing the message flow and processes. As illustrated in FIG. 2, the software 116 comprises predictive text entry (PTE) message composition program 201, outbox 202, message handler 203, sent messages corpus 204, compression model manager 205, statistical model for compression 206, and search engine 207.

Until the subscriber 1 has actually sent some messages, there will be no “real” sent messages in the sent messages corpus 204. Consequently, when subscriber 1 first begins to use the system, the sent messages corpus 204 will be populated with a set of suitable predefined messages, for example a set of “typical” messages. The search engine 207 uses lexical and semantic databases to provide enhanced text-mining capabilities, in this embodiment, Wordnet™ 208, a lexical and semantic database of the English language available from Princeton University. It also uses a custom thesaurus database 209. It should be noted that application specific terminology might not be included in the generic “lexical and semantic” databases, in which case the custom thesaurus 209 would supplement it.

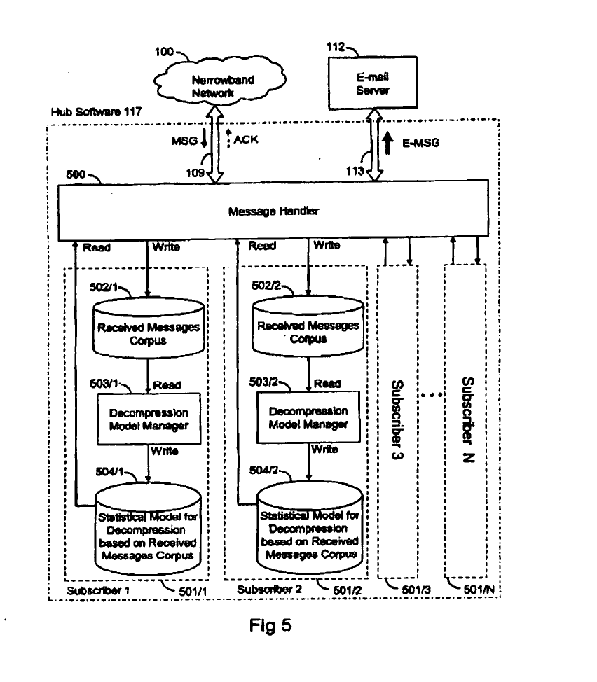

The PTE message composition program 201 uses the search engine 207 to mine the sent messages corpus 204, which was used to build the statistical model for compression 206, and formulate suggestions based upon the result RSLT. Given the use of previously sent messages in the corpus 204, upon which the compression model 206 is based, the compression method used in this ease is adaptive. That is to say that the statistical model for compression 206 is updated with every message successfully sent over the narrowband network 100. The same adaptive scheme applies to the corresponding statistical model for decompression at the messaging hub 108, which will be described later with reference to FIG. 5.

The PTE message composition program 201 interfaces with the user input interface and the display unit of the messaging device 110 to allow subscriber 1 (the composer) to enter characters for the purpose of composing a message. While subscriber 1 is entering characters, the PTE message composition program 201 uses one or more of the entered characters to form a query QRY which it submits to the search engine 207, as indicated by line 210.

The query QRY also specifies search engine options such as stemming, phonic, fuzzy and synonym searching. The search engine 207 then searches (mines) the sent messages corpus 204 and, optionally, Wordnet™ 208 and custom thesaurus 209 and returns to the PTE message composition program 201, as indicated by line 211, a query result RSLT comprising the most relevant words, phrases and messages (Sec also Box 301 of FIG. 3). It should be noted that the search engine 207 could search either or both of the lexical or semantic database and the thesaurus.

The PTE composition program 201 then formulates suggestions based on the query result RSLT and, given the limited available space on the display of the messaging device 110, displays those that are most relevant, with emphasis, as will be defined later, on those that were obtained from the sent messages corpus 204. As a result, the PTE composition program 201 adds redundancy, thereby improving compressibility, as well as facilitating message composition.

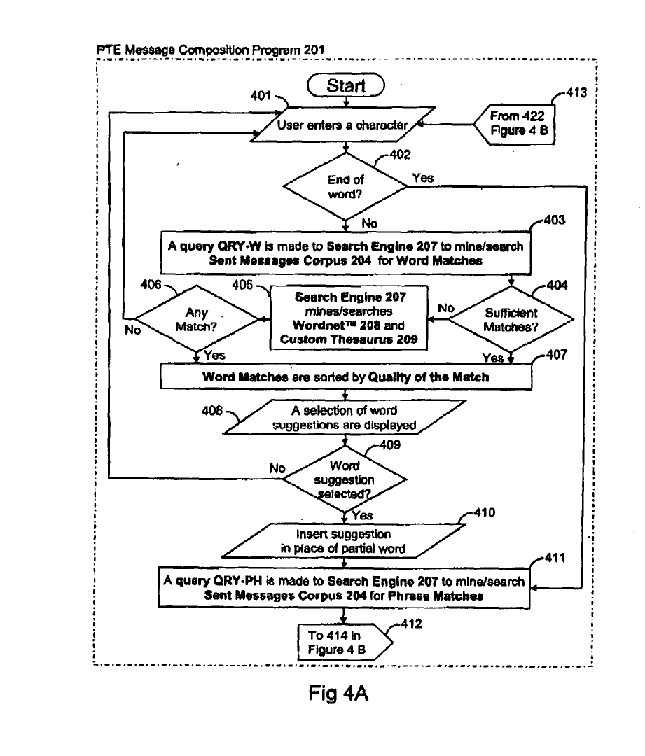

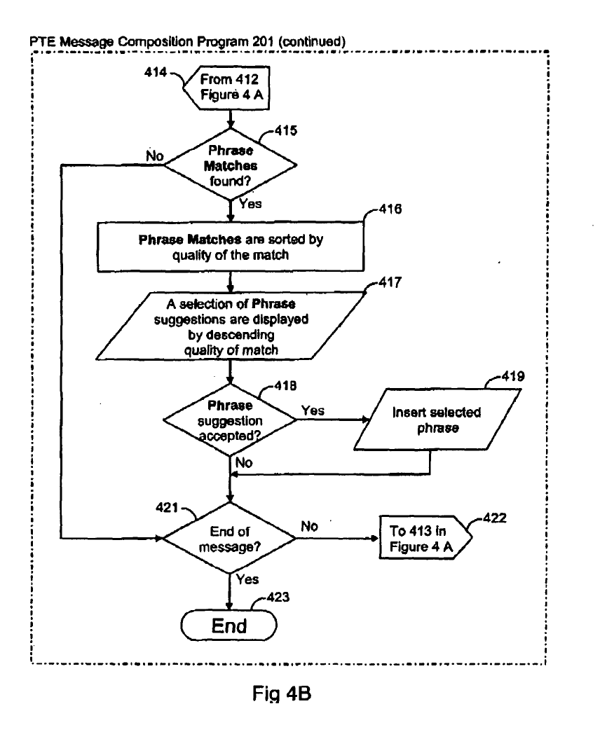

FIGS. 4A and 4B together illustrate the message composition program 201 in more detail. In step 401, the program 201 detects that the user has entered a character and in decision step 402 determines whether or not the character completes is a word, for example, a white space or punctuation is a delimiting character indicating the completion of a word.

If the entered character does not complete a word, in step 403 the program 201 uses the entered character(s), optionally including previously entered words as context, to form a word search query QRY-W and submits it to the search engine 207 for it to use to mine/search the sent messages corpus 204 for word matches. If decision step 402 indicates that a word was completed, in step 411 the program 201 submits a first phrase query QRY-PH to the search engine 207 to mine/search the sent messages corpus 204 (FIG. 2) for phrase matches, i.e., to mine the corpus 204 for pertinent phrases containing or suggested by the completed word and, if appropriate, one or more of the previously entered words.

Searches could include predetermined timeouts to abort the search and display suggestions based on what has been found/mined so far. The predetermined time-out would be short enough such that suggestions are generally displayed before the user enters another character. If the user enters a character before any suggestions are displayed, the current search is aborted with no suggestions displayed, and a new search is initiated based on the new entry.

In step 404, the program 201 determines whether or not an insufficient number of, or no, word matches were found by the word search. If not, the program 201 instruts the search engine 207 to mine/search Wordnet™ 208 and/or custom thesaurus database 209 for additional matches, as shown in step 405. Thus, the searching of Wordnet™ 208 and the thesaurus database 209 is optional, being unnecessary if sufficient word matches were found by the corpus search 403.

The resulting additional suggestions from the Wordnet™ 208 and custom thesaurus 209 searches are not intended to contribute to message redundancy and hence improved compressibility; their intended function is to aid in composition. If decision step 406 indicates that no matches were found by either search (steps 403/405), the program 201 returns to step 401 and waits for another character to be entered.

If the result of decision step 406 is that sufficient word matches were found, in step 407 the program 201 sorts the words by the quality of match and in step 408 formulates a selection of word suggestions and displays them to the user. In this context, the “quality” of a word match is a metric based on a combination of textual and conceptual similarity of the match and, optionally, its surrounding words in the corpus, relative to the query, with an emphasis on those that are from the sent message corpus 204, and further emphasis upon those used in messages recently added to the sent messages corpus 204.

In this context, “emphasis” is a multiplier applied to the quality of match metric, thereby increasing the likelihood of the emphasized match appearing as a displayed suggestion. It should be noted that the emphasis on recently added messages is justified because repeated adoption of suggestions from recently added messages will eventually build increased redundancy throughout the sent messages corpus 204, leading to improved compressibility the next time that a suggestion from a recent message is adopted.

If decision step 409 indicates that the user failed to select a suggestion, the program 201 returns to step 401 and waits for another character to be entered. If step 409 indicates that the user selected a suggestion, the program 201 inserts the suggestion in place of the partial word being composed.

Should decision step 402 indicate that the user completed a word, as indicated by insertion of a word delimiting character, such as white space or punctuation, or accepting a selection (step 409) and thereby completing a word; in step 411 the program 201 instructs the search engine 207 to conduct a phrase search. If the result of decision step 415 (FIG. 4B) is that no phrase matches were found, and the user has not yet completed his composition, as indicated by a negative result of step 421, the program 201 returns to step 401 (FIG. 4A) and waits for another character to be entered. If step 421 indicates that the user has finished composing the message, however, the program ends at terminator 423.

If decision step 415 indicates that phrase matches have been found, in step 416 the program 201 sorts them by quality of match and, in step 417, formulates a selection of phrase suggestions and displays the suggestions to the user.

The quality of a phrase match is a metric based on a combination of textual and conceptual similarity of the phrase match in the corpus 204 relative to the query, with an emphasis on those used in messages recently added to the sent messages corpus 204. As before, emphasis is a multiplier applied to the quality of match metric, thereby increasing the likelihood of the emphasized match appearing as a displayed suggestion.

If decision step 418 indicates that the user accepts a phrase suggestion, in step 419 the program inserts it, following which it can be edited by the user if required. The program terminates in step 423 when the user has finished composing the message; otherwise, the process continues.

Referring again to FIGS. 2 and 3, when subscriber 1 (the user) considers the message to be completed, and presses “send” or otherwise initiates transmission of the message, the PTE message composition program 201 writes it into the outbox 202 (see Box 302).

The message handler 203 reads the message from the outbox 202, compresses it by mapping the contents of the message with the statistical model for compression 206 (see Box 303), formats it for transmission, and then sends it via the network access device 101, over the return path described with reference to FIG. 1, to the addressee's e-mail account (Inbox) at e-mail server 112 (see Box 304). Prior to forwarding the message MSG, the network access device 101 adds a subscriber ID according to standard practice.

Once the message handler 203 receives an acknowledgement message ACK confirming receipt of the message MSG by the messaging hub 108, as indicated by broken line beside link 111 (FIG. 2), it writes the message MSG to the sent messages corpus 204 and removes it from the outbox 202 (see Box 305). Once the message MSG is in the sent messages corpus 204, the compression model manager 205 uses it, along with the other messages in the sent messages corpus 204, as a basis from which to build the statistical model for compression 206 (see Box 306).

Sharing the sent messages corpus 204 with the search engine 207 predisposes the PTE message composition program 201 to suggest preferentially all or part of one of more messages that were used as a basis from which the statistical model for compression 206 was built. This facilitates the achievement of high compression ratios.

The compression model manager 205 regenerates the statistical model for compression 206 (Box 306) every time a change is made to the sent messages corpus 204. A complete update of the statistical model for compression 206 every time a newly-sent message is added ensures that the model is optimal. It should be noted, however, that the statistical model for compression 206 could be updated only after several changes to the sent messages corpus 204 without significantly affecting performance.

It should also be noted that process step 305 (FIG. 3) presents the option of a fixed size sent messages corpus 204. For example, the sent messages corpus 204 could be sized at 1000 messages. Upon initialization, the 1000 messages would consist of predefined messages only. Every time a new sent message was added, the oldest one would be deleted to maintain a fixed number of messages. This would ensure that the corpus 204, upon which the statistical model for compression 206 is based, comprises newer messages to adapt to changing message composition patterns.

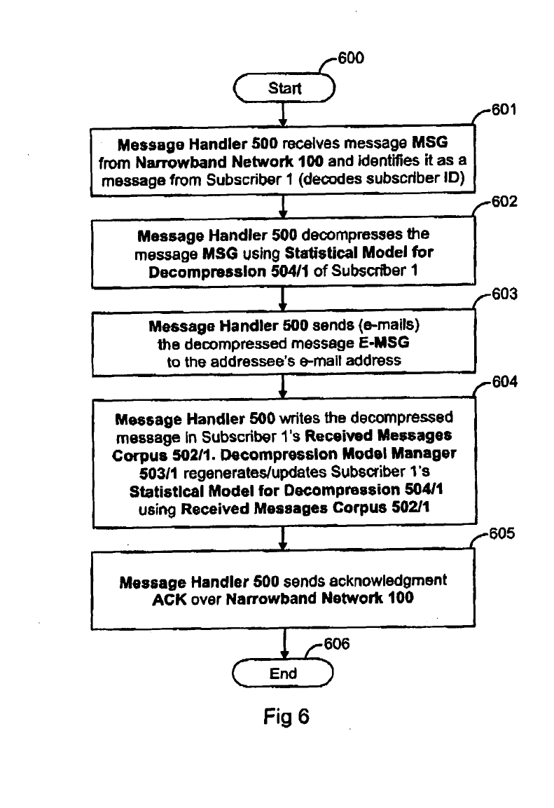

Processing of the message MSG by the messaging hub 108 (FIG. 1) will now be described with reference also to FIGS. 5 and 6, FIG. 5 illustrates the modules of hub software and data 117 that reside in the messaging hub 108, while FIG. 6 summarizes the message flow and processes.

The messaging hub 10B must handle messages from and to a plurality of N subscribers, so it has a common message handler 500 which communicates with one of a corresponding plurality of N modules 501/1 to 501/N when processing incoming messages from a particular subscriber. Each module “501/n” comprises a received messages corpus 502/n, a decompression model manager 503/n and a statistical model for decompression 504/n, specific to the corresponding subscriber n. The message handler 500 also generates acknowledgement messages ACK to send to the messaging device 110 of the particular composer of a message MSG.

Because adaptive compression is used, in normal operation each of the received messages corpora 502/1 to 502/N will differ from the others, as will each of the statistical models for compression 504/1 to 504/N. Consequently, upon receipt of the compressed message MSG from subscriber 1, via the narrowband network 100, the message handler 500 decodes the subscriber ID for subscriber 1 embedded within the message MSG by the network access device 101 (see Box 601, FIG. 6).

The message handler 500 uses the subscriber ID to select and read the statistical model for decompression 504/1 specific to subscriber 1 (see Box 602). The message handler 500 then reformats the decompressed message into an e-mail message E-MSG addressed to the addressee's e-mail address which was included in the message MSG by subscriber 1 using the messaging device 110. To summarize, the message MSG includes system-reserved bits, an uncompressed subscriber ID and compressed content, which includes the addressee's e-mail address, the subject field and the message body.

The message handler 500 adds the return e-mail address of subscriber 1 (previously stored as part of subscriber 1's user profile) and any other standard or user-specific information and transmits the e-mail message E-MSG via link 113 to the e-mail server 112 (see Box 603). The message handler 500 may also include the address, e.g. Uniform Resource Locator (URL) address, of reply page in an Internet web site which will allow the addressee to use an Internet browser program to compose a reply using software installed in the messaging hub 108, as will be described more fully later.

The message handler 500 then adds the decompressed message MSG to the received messages corpus 502/1 for subscriber 1. Every time a newly-received message is added, the oldest one is deleted so that the received messages corpus 502/1 mirrors the sent messages corpus 204. The decompression model manager 503/1 regenerates/updates the statistical model for decompression 504/1 based upon the updated received messages corpus 502/1 (see Box 604). This ensures that the statistical model for decompression 504/1 is ready for the next message from subscriber 1.

The message handler 500 also generates a message acknowledgement ACK and transmits it to the messaging device 110 via the narrowband network 100 (see Box 605). On receipt of the acknowledgment Message ACK, message handler 203 (see FIG. 2) in messaging device 110 proceeds to add the sent message MSG to its sent messages corpus 204, as described hereinbefore, subsequently initiating the update of the statistical model for compression 206.

The statistical model for compression 206 (FIG. 2) of messaging device 110 and the corresponding statistical model for decompression 504/1 (FIG. 5), and hence the sent and received messages corpora 204 and 502/1, respectively, are kept synchronized. Given the importance of keeping the statistical model for compression and decompression identical, the messaging device 110 includes a rolling statistical model version number which it includes as overhead in the system-reserved bits of the message MSG it sends to the messaging hub 108. This also necessitates keeping multiple versions of the statistical model for decompression 504/1.

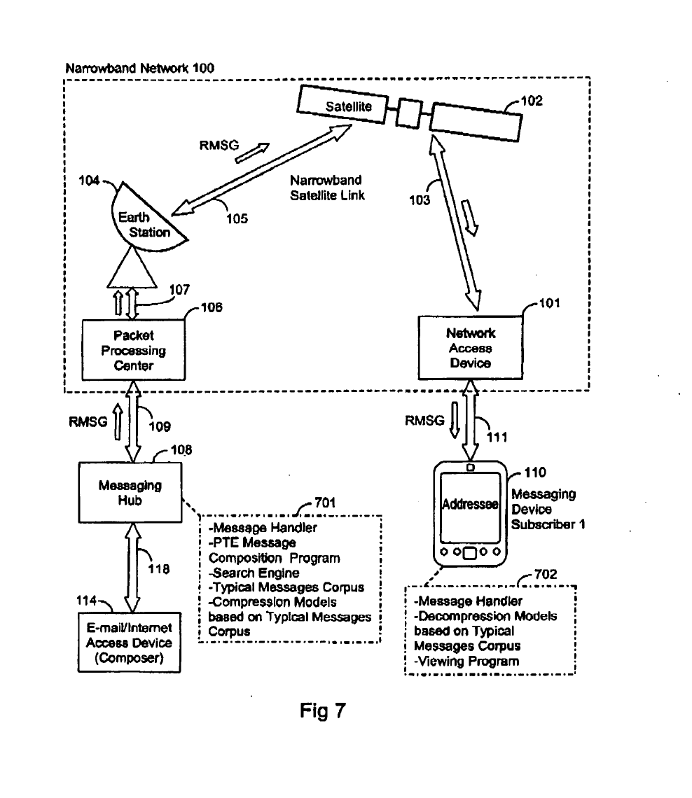

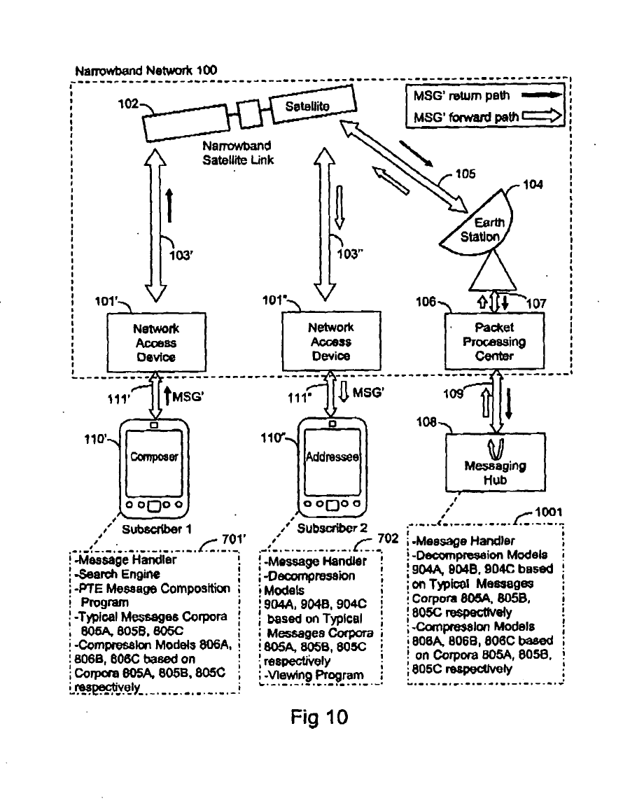

It will be appreciated that, when the addressee receives the message E-MSG at his e-mail/Internet access device 114, he will probably wish to reply. If the addressee also is a subscriber, he may also have a messaging device similar to that used by subscriber 1 and hence capable of composing a reply in a similar manner, as will be described later with reference to FIG. 10. If not, the original addressee, who now is the replying composer, may reply using software on the messaging hub 108 to compose a message for transmission via the narrowband network 100 to the messaging device 110 for decompression by software installed on the messaging device 110. Such an arrangement, together with a different type of compression, will now be described with reference to FIGS. 7 to 9.

The messaging hub 108 shown in FIG. 7 also has message composition software 701 that an Internet browser residing on a device such as e-mail/Internet access device 114 can access in order to compose a reply message RMSG. The messaging device 110 also has message decompression software 702. Although the elements of software 701 and 702 are similar to elements of software 116 and 117 described hereinbefore, in this case, messages RMSG sent by the messaging hub 108 to messaging device 110 are compressed using a static compression scheme.

Instead of using a single adaptive sent messages corpus 204, several typical messages corpora are used. The corpus selected by the replying composer is identified in the transmitted message RMSG to enable the messaging device 110 to identify the corresponding corpus and statistical model required to decompress the message RMSG and then display it for viewing by subscriber 1.

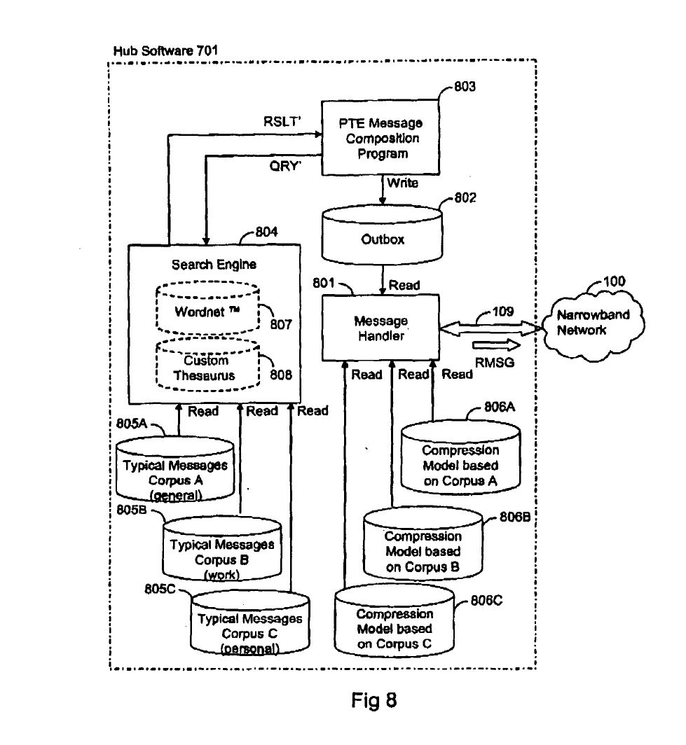

FIG. 8 illustrates the elements and functionality of the hub software and data 701 in the messaging hub 108 (FIG. 7). The hub software and data 701 comprises a message handler 801, which has access to the narrowband network 100 via link 109, an outbox 802, a PTE message composition program 803, a search engine 804, three typical messages corpora 805A, 805B and 805C, and three compression models 806A, 806B and 806C based on corpora 805A, 805B and 805C, respectively. In addition to having access to the corpora 805A, 805B and 805C, the search engine 804 has access to a lexical and semantic database 807, specifically Wordnet™, and a custom thesaurus 808, similar to those used by the search engine 207 shown in, and described with reference to, FIG. 2.

Thus, hub software and data 701 generally similar to software and data 116 (FIG. 2), with the key difference being that hub software 701 uses a static compression scheme with three typical messages corpora 805A/805B/805C, whereas messaging device software 116 uses an adaptive compression scheme with a single sent messages corpus 204. The PTE message composition program 803 uses the same algorithm as PTE message composition program 201 (FIG. 2), but is adapted to run as part of the messaging hub 108 and mine a selected one of the typical messages corpus instead of the single sent messages corpus 204 used by the messaging device 110 when composing message MSG.

To compose and send message RMSG, the replying composer uses e-mail/Internet access device 114 to access the Internet web page whose URL was included in the e-mail message E-MSG by the messaging hub 108, using a password if appropriate. This Internet web page will pre-address the reply message in known manner to the subscriber ID, or a predetermined alias of subscriber 1. It should be noted that a user could access the message composition Internet web page directly via the Internet browser on-Internet access device 114 in order to use the messaging hub software 701 to compose an initial message (as opposed to a reply), in which case, the composer would have to address the message to subscriber 1 manually, using his subscriber ID or a predetermined alias.

Before entering any message text, the replying composer first selects one of the three typical messages corpora 805A, 805B and 805C for use by the message handler 801. Each of the three corpora 805A, 805B and 805C, which will have been previously stored on the messaging hub 108 in association with an administrative profile for subscriber 1, corresponds to a predetermined message kind or context.

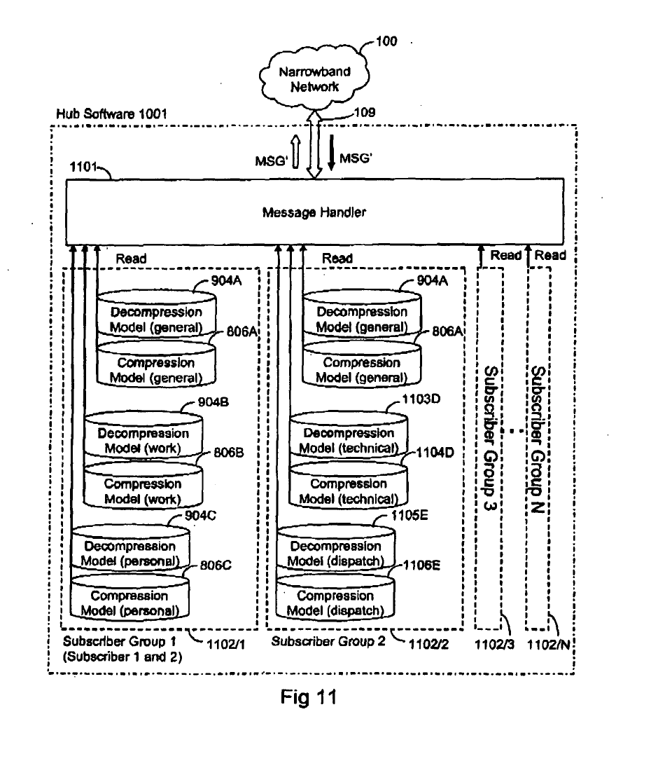

In this preferred embodiment, corpora 805A, 805B and 8050 correspond to “general”, “work” and “personal”, respectively. As will be discussed later with reference to FIG. 11, subscribers can be grouped and have common corpora to facilitate communication within groups.

Assuming that the message RMSG is work-related, as the replying composer is composing it using device 114, the PTE message composition program 803 makes its suggestions based upon the typical message corpus 805B (work). More particularly, while the composer is entering characters, the PTE message composition program 803 uses one or more of the entered characters to form a query QRY′ to the search engine 804. As Wore, the query QRY′ also specifies search engine options such as stemming, phonic, fuzzy and synonym searching.

The search engine 804 then searches the selected typical messages corpus 3D 805B, and, if required Wordnet™ lexical and semantic database 807 and custom thesaurus database 808, and returns a reply RSLT′ containing the most relevant words, phrases or even entire messages to the PTE message composition program 803. The PTE message composition program 803 then formulates suggestions based on the query result RSLT and displays those that are most relevant, with an emphasis on those that are from the selected typical messages corpus 805B as opposed to those that are from the Wordnet™ lexical and semantic database 807 and custom thesaurus database 808.

As before, the replying composer may accept or reject (ignore) the suggestions. Once the message has been completed, and sent by the replying composer, the PTE message composition program 803 writes it to the outbox 802. The message handler 801 reads the message from the outbox 802, compresses it by mapping the contents of the message with the statistical model for compression 806B based upon the selected corpus 805B, formats it for transmission and then sends it to subscriber 1, identified by his subscriber ID or a predetermined alias, via link 109 and narrowband network 100 to the messaging device 110. It should be noted that message acknowledgement ACK and compression/decompression model updates are not required because the static (as opposed to adaptive) compression scheme is used.

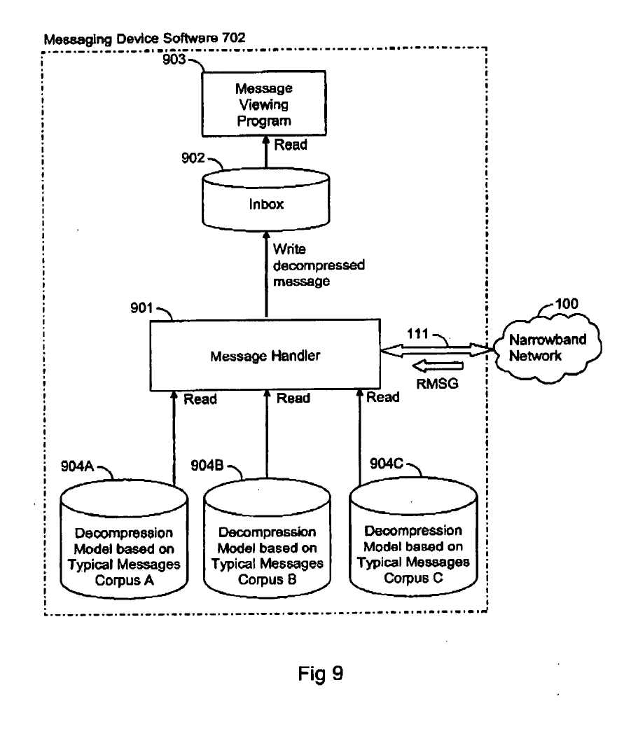

On receipt of the message RMSG, the messaging device 110 (FIG. 7) decompresses it using software and data 702 that resides in the messaging device 110 and, as illustrated in FIG. 9, comprises message handler 901, inbox 902, message viewing program 903 and three decompression models 904A, 904B and 904C based upon typical messages corpora 805A, 805B and 805C, respectively.

Software and data 702 is generally similar to one subscriber module of the software and data 117 installed on the messaging hub 108 and illustrated in FIG. 5, with the most significant difference being that software 702 uses a static decompression scheme with statistical models for decompression 904A/904B/904C based on typical messages corpora 805A/805B/805C, whereas software 117 uses an adaptive decompression scheme with a received messages corpus 502/n.

When it receives message RMSG from the narrowband network 100, the message handler 901 identifies the selected corpus (805B) identifier, included in the system-reserved bits of message RMSG and uses the appropriate statistical model for decompression 904B (work) to decompress the message RMSG, following which it writes the decompressed message to the inbox 902. The message viewing program 903 then allows the contents of the inbox 902 to be viewed by the addressee (now subscriber 1).

It should be noted that, if both the composer and the addressee are subscribers, they will each use a messaging device 110 that both sends and receives compressed messages. If narrowband network 100 were able to support peer-to-peer messaging between two such messaging devices 110, the peer-to-peer functionality within the messaging hub 108 would not be required. In this specific embodiment, however, the narrowband network 100 does not support such direct peer-to-peer messaging, so their messages would still need to be routed via the messaging hub 108. Such an arrangement, using static compression for reasons to be given later, will now be described with reference to FIGS. 10 and 11.

Thus, FIG. 10 illustrates a messaging system in which a first messaging device 110′ used by subscriber 1 and a second messaging device 110″ used by subscriber 2 communicate via narrowband network 100 and a messaging hub 108. The first messaging device 110′ is equipped with software 701′ that is similar to that installed on the messaging hub 108 of FIG. 7 in that it comprises a message handler, a search engine, a PTE message composition program, a set of three typical messages corpora and a set of three compression models each based upon a respective one of the three corpora.

The second messaging device 110″ is equipped with software 702 that is the same as that installed on the messaging device 110 of FIG. 7 and thus comprises a message handler, a set of three decompression models each based upon a respective one of the three typical messages corpora and a viewing program.

The messaging hub 108 is equipped with hub software 1001 that is similar to hub software 701 (FIGS. 7 and 8) but differs in that it also has decompression software but no PTE message composition program 803. This is appropriate because, in this embodiment, the messaging hub 108 merely serves to relay the messages to and from the messaging devices.

The narrowband network 100 is similar to that shown in FIG. 1 but with an additional network access device 101″ associated with the additional messaging device 110″; thus there are two network access devices 101′ and 101″ connected to first and second messaging devices 110′ and 110″, respectively. In FIG. 10, messaging device 110′ is the composer and messaging device 110″ is the addressee. For peer-to-peer or subscriber 1-to-subscriber 2 communications, the embodiment illustrated in FIG. 10 uses a static compression scheme. The reason for using a static scheme in this case is to maintain consistency in compressed message size.

If an adaptive scheme (as per FIGS. 1 to 6) were to be used, suggestions made by the PTE message composition program 803 (similar to PTE message composition program 201) during composition would maximize redundancy relative to the sent messages corpus of subscriber 1, which could be quite different from the typical messages corpora upon which the decompression models, in the messaging hub, are based. This could lead to significant and unpredictable expansion of the message at the messaging hub 108 during recompression. Unpredictable expansion in compressed message size would discourage the use of subscriber-to-subscriber messaging and is therefore undesirable.

Since the messaging device 110′ and messaging hub 108 may be used for subscriber-to-external-addressee messaging, as described with reference to FIGS. 1 to 6, or for peer-to-peer messaging as illustrated in FIG. 10, the messaging device 110′ has software enabling it to use both adaptive and static compression (but only static decompression) and the messaging hub 108 has software enabling it to use static compression but both static and adaptive decompression.

Accordingly, when transmitting subscriber 1's composed message MSG′ to the messaging hub 108, the messaging device 110′ will include in the transmitted message MSG′ both an address for the addressee, subscriber 2; and an identifier, included in the system-reserve bits, which allows the software 1001 at the messaging hub 108 to determine which of the subscriber groups 1102/1 to N to use and, within that subscriber group 1102/n, which of the statistical models for decompression 904A, 904B and 904C to use.

Thus, when composing the message MSG′ on the messaging device 110′ using software 701′, subscriber 1 identifies the message addressee (subscriber 2) as being another subscriber and subsequently selects, in this example, the “personal” corpus 805C. Software 701′, which is not illustrated in a separate figure, is very similar to software 701 on the messaging hub 108, with the key difference being that the software is adapted to the messaging device 110′. It should be noted that messaging device 110′ will have static compression software 701′, static decompression software 702 and adaptive compression software and data 116. Although they are shown and described separately herein, in practice they will be integrated into a single software program. (The same applies to other embodiments).

Once composed using software 701′, in the manner described hereinbefore, the transmitted message MSG′ is sent over the narrowband network 100 and is received at the messaging hub 108, where it is decompressed. Once the message MSG′ has been decompressed, the message handler 1101 (see FIG. 11) identifies the addressee (subscriber 2) as being another subscriber; consequently, the message MSG′ will need to be forwarded through the narrowband network 100 again.

Accordingly, the message handler 1101 will reformat the message MSG′, adding the subscriber ID or a predetermined alias to identify subscriber 1 as the message originator, and recompress the message MSG′ using hub software 1001 (see also FIG. 11) and the corresponding statistical model for compression 806C (personal), and appropriately set the compression model identifier in the system-reserved bits before re-transmitting it over the narrowband network 100 to messaging device 110″ of subscriber 2. On its receipt at messaging device 110′, the message handler will detect the decompression model used to compress the message and then decompress and display it for viewing in a manner similar to that described with reference to the embodiment of FIG. 9.

Use of statistical models based upon the same corpus at both, the messaging hub 108 and the respective one of the messaging devices 110′ and 110″ maintains consistent compressed message size throughout.

It should be noted that messaging hub 108 will have static decompression software 1001, static compression software 701 and adaptive decompression software and data 117. Although they are shown and described separately herein, in practice they will be integrated into a single software program.

FIG. 11 illustrates the hub software 1001 that resides in the messaging hub 108 of FIG. 10. In the previously described embodiments, each subscriber has a unique corpus or set of corpora assigned to it. As intimated, however, it is envisaged that subscribers could be organized in groups, each group using a common corpus or set of corpora. This arrangement requires modification of the software and data at the messaging hub 108. Thus, for each of N groups of the subscribers 1102/1 . . . 1102/N, the messaging hub software 1001 has a set of compression and decompression models which are used to process messages to/from all subscribers in that group. For the purposes of this description, the first group, subscriber group (1) 1102/1 is assumed to consist of subscribers 1 and 2.

When message MSG′ is received, the message handler 1101 detects the subscriber identifier of subscriber 1 and determines that it must use software and data set 1102/1 for the group comprising subscribers 1 and 2. Having also detected the corpus identifier, also included in the system-reserved bits of message MSG′, the message handler 1101 retrieves/selects the appropriate statistical models for decompression and compression 904C/806C (personal). The message handler 1101 decompresses, reformats (identifying the message originator) message MSG′, then recompresses and resends message MSG′ via the narrowband network 100 to the addressee, i.e. subscriber 2.

Subscribers are grouped to allow each of the different groups to have a set of typical messages corpora carefully formulated to correspond to messaging between subscribers of that group. Given that subscribers are more likely to communicate within their group and, when doing so, use similar words and phrases, providing group-specific profiles helps to improve static compression performance.

To facilitate messaging between subscribers who are members of different subscriber groups, which, albeit less frequent, still requires consistency in compressed message size, the different subscriber groups have at least one set of compression and decompression models that are the same as shown in FIG. 11 with the “general” statistical compression model 806A and statistical decompression model 904A in 1102/n.

Should a subscriber 1 send a message to a subscriber in a different group, say a subscriber 3 (not shown), and fail to select the “general” corpus 805A, the message handler 1101 may attempt to send the message MSG′ if the expansion is within predetermined acceptable limits and, optionally, send a warning to the subscriber 1. Should the expansion be outside of acceptable limits, the message handler 1101 would send an error message to the subscriber 1. It should be noted that, for convenience of illustration and description, the above-described embodiments have been depicted as having certain combinations of features, such as static compression combined with groups of subscribers sharing the same decompression/compression model. That does not, however, preclude the use of other combinations.

Devices embodying the present invention provide a method for text entry that increases the redundancy of the entered text, and hence facilitates the achievement of high compression ratios. PIE suggestions are related to the statistical model for compression, in that words and phrases taken from the messages corpus used as a basis from which to build the statistical model for compression are suggested via the user interface of the device (messaging device or e-mail/Internet access device). This increases redundancy of the message relative to the messages corpus.

Facilitating redundancy may lead to very significant gains in compressibility. The long string of characters associated with a phrase can be replaced with several bits. Embodiments of the present invention which employ state-of-the-art compression techniques, such as those disclosed in the article by S. Rein, C. Mann and F. H. P. Fitzek entitled “Low-Complexity Compression of Short Messages”, Proceedings of the IEEE Data Compression Conference (DCC'06), 2006, can provide particularly high compression ratios.

While preferred embodiments of the invention have been illustrated and described, it will be appreciated that various changes can be made thereto without departing from the spirit and scope of the invention. For example, those skilled in the art will appreciate that the use of different compression schemes will necessarily alter the architecture. For example, the use of a ZLIB-like compression scheme would result in the sent messages corpus 204 and the dictionary equivalent of the statistical model for compression 206 being the same database, thereby eliminating the need for the compression manager 205.

Furthermore, where adaptive compression is used, changes could be made in the way that the sent messages corpus 204 is updated. Thus, if communications patterns indicated the frequent re-use of segments of received messages in composed messages, such as replies, both received and sent messages could be used to update the subsequently renamed “sent/received” messages corpus. This would require appropriate message level acknowledgements to ensure synchronization of corpora and models at the messaging hub 108 and messaging device 110.

Moreover, a number of different schemes could be used to mine the corpora for matches to the partially-entered words and phrases. For example, each of the above-described embodiments uses a search engine to mine the corpus or corpora directly. Other approaches could include the parsing and extraction of words and phrases to form a structured PTE database. This would substantially change the way in which the corpora are mined, without departing from the scope of the invention.

Different approaches for ranking matches could be used, which would affect which matches get displayed to the user/composer as PTE suggestions. Methods for ranking could include sorting based upon complex metrics combining many parameters, including those derived from natural language processing techniques including word sense disambiguation, to simple rule-based rankings which assign an equal value to all matches, sorting instead by the number of bits with, in the adaptive case, priority given to recent matches from the sent messages corpus. These and other techniques are familiar to those skilled in the art of natural language processing, text mining, and search engine design and so need not be described in detail herein.

Also, depending on the objectives of the final application, whether it is primarily to facilitate compression or to facilitate text entry, the addition of a PTE database dedicated for text entry could be desirable. For example, if the application included an ambiguous keyboard, such as those found on some mobile phones, the user would enter a word first with the aid of the dedicated PIE database, and once the word was completed, word and phrase suggestions would be made. This would change the way in which suggestions were made, without departing from the scope of the invention.

Moreover, depending on the physical constraints of the display, data entry method, as well as computing resources available, a number of changes could be made to simplify or expand the algorithms without departing from the scope of the present invention. For example, if a very large display were used, multiple words, phrases and entire messages could be displayed. Additionally, the messaging device could employ speech recognition and synthesis, enabling the input text to be derived directly from the user's utterances, with suggestions made via a speaker. Given substantially increased computing resources, a number of techniques for finding word and phrase matches could be used in combination. Furthermore, feedback on the estimated compressed message size could be provided in real-time during composition to guide the user in his message composition choices. With decreased computing resources, searches could be limited in time to ensure responsiveness.

Additionally, hybrid adaptive/static corpora could be used. Thus, the send messages corpus 204 could comprise a hybrid corpus having an adaptive corpus section and a static corpus section. For example, the first 500 messages in the 1000 messages hybrid corpus could be in the adaptive corpus section with the oldest of the 500 being deleted when a new message is added. The second 500 messages could be in the static corpus section and would remain regardless of the number of messages added to the adaptive corpus section. This hybrid corpus and the corresponding hybrid corpus updating scheme would be the same on the messaging device 110 and the messaging hub 108.

It is also envisaged that static compression could be used throughout the system, as opposed to the disclosed mix of adaptive and static, potentially with an increased number of user-selectable corpora. Conversely, the system could use adaptive compression throughout, potentially at the expense of privacy and complexity. In embodiments of the invention which use a static compression scheme using several different typical messages corpora, redundancy is increased beneficially relative to the selected message corpus in much the same way as the adaptive text compression case.

Reasons for selective use of a static scheme in the preferred embodiment include simplicity and privacy. To avoid having to create separate sender-subscriber specific accounts, an adaptive message corpus would have to be shared. In the adaptive ease, word, and particularly, phrase suggestions, would disclose segments of private messages. Because the typical messages corpora contain only generic information, their use avoids this problem.

It should be noted that the provision of multiple corpora which can be selected individually by the user is not limited to the static compression embodiments described herein. It is envisaged that the messaging device 110 could employ two or more adaptive corpora instead of the single sent messages corpus 204, end allow the user to select one. Each of the corpora would be updated and used for the adaptive compression scheme as before.

It will be appreciated that the link 109 between the packet processing centre 106 and the messaging hub 108, and the link 113 between the latter and the e-mail server 112, (see FIG. 1) could be by way of the Internet or some other private or public data network.

With respect to connections to the messaging hub 108 to allow external users to send messages to a subscriber, multiple options are possible. In addition to the message composition Internet web page disclosed hereinbefore, the external sender could have software installed on the e-mail/Internet access device 114 to allow messages to be composed on a device embodying the present invention and subsequently sent to the subscriber via the messaging hub 108.

Furthermore, the system could allow external users to send e-mail messages to subscribers, using a subscriber specific messaging service e-mail address (e.g. 00000011@messaging_service.com), without the benefit of the increased compressibility afforded by embodiments of the present invention. Typically, this would necessitate rule-based message processing, such as stripping attachments and message truncation, to limit message size and hence message cost.

Message processing rules would be stored within the administrative profile of the subscriber. Furthermore, the system could be combined with an e-mail integration service that would allow subscriber-specific messaging accounts to be integrated with external Internet service provider (ISP) e-mail accounts. As is well known in the art of mobile messaging and more particularly, “push” e-mail, the e-mail integration service is integrated with or attached to the ISP e-mail system and monitors the ISP e-mail server. When the e-mail integration service sees new o-mail for a subscriber, it retrieves (pulls) a copy and then sends (pushes) it to the subscriber's messaging service e-mail address.

To allow the subscriber to have better control over message cost, the messaging hub 108 could send a “preview” of a long incoming message to allow the subscriber to decide whether to accept a message that exceeds the message size limit in his administrative profile.

Moreover, to facilitate the subscriber's long term storage and management of messages sent over the disclosed messaging system, some or all of the message transactions in his account could be forwarded (“CC”) to an external email account in accordance with the settings in the subscriber's administrative profile.

Additionally, although not mentioned explicitly in the preferred embodiments, the messaging system could include that ability to send a single message to multiple recipients. Broadcast messages to groups of subscribers could also be supported.

It should be noted that e-mail is mentioned throughout this document to describe an electronic message sent to an external addressee. This is intended to include any present or future electronic mail, instant messaging or other equivalent massaging protocol.

The above-described system has a single messaging hub 108 connected tp the packet processing center 106. It should be noted that several networked messaging hubs 108 could be connected to the packet processing center 106 for traffic handling or other reasons. The list of subscriber IDs associated with a particular messaging hub would be stored on the packet processing center 106 which would route messages accordingly.

Conversely, one or more messaging hubs 108 could support multiple packet processing centers 106 and hence multiple narrowband networks. The list of subscriber IDs associated with a particular packet processing center 106 would be stored on the respective messaging hub 108 which would route messages accordingly.

Although the above-described messaging system embodiments use a narrowband network with certain characteristics and limitations, such as not supporting peer-to-peer messaging, it will be appreciated, that embodiments of the present invention are not limited to narrowband networks but could be adapted to any network, with the appropriate modifications.

It should also be appreciated that the “quality” metric used by the above-described embodiments could be augmented by some other measure of the phrase match or word match, for example compressibility or frequency of use.

It should be noted that the disclosed messaging device 110 could be adapted for connection to other communication systems including, video, voice, internet access, messaging and other capabilities. These devices could be used in conjunction with the disclosed system, optionally with a higher level application managing connectivity based on the capability of the devices, such as 802.11 (“Wi-Fi”) and terrestrial mobile data networking (e.g. GPRS) capability.

Lastly, other methods to introduce redundancy, thereby facilitating compression, can be used in combination with those embodying the present invention as described herein. For example, a library of carefully formulated message templates could allow the user/subscriber to re-use words and phrases. The message templates would include text that has a high degree of redundancy relative to other templates as well as the typical messages corpora used in the static scheme and initial sent messages corpus 204.

In fact, the typical messages corpora could include messages based on these templates. A utility could be provided to allow the subscriber to manage and customize the message template library. A similar program could also allow the user to manage and customize his “sent” and “typical” messages corpora, including facilitating synchronization of this data at the messaging device 110 and the messaging hub 108.

It should be noted that, due to the bidirectional nature of the disclosed messaging system, the messaging devices and the messaging hub will usually include both compression and decompression software, and, in most oases, message composition software.

### INDUSTRIAL APPLICABILITY

Advantageously, embodiments of the invention in which the predictive text entry and compression use the same corpus provide increased redundancy of the message relative to the message corpus. Facilitating redundancy may lead to very significant gains in compressibility. The long string of characters associated with a phrase can be replaced with several bits.

The reader is directed for reference specifically to each of the patent documents and technical articles mentioned herein, whose contents are incorporated herein by reference.

Although embodiments of the invention have been described and illustrated in detail, it is to be clearly understood that the same are by way of illustration and example only and not to be taken by way of limitation, the scope of the present invention being limited only by the appended claims.

1. A text messaging system comprising:
means for composing, compressing and transmitting text messages and means for receiving and decompressing the compressed text messages,
the composing, compressing and transmitting means having means for predictive text entry during composition of a message (MSG) in conjunction with means for compressing the composed message (MSG) and transmitting the compressed message to the receiving and decompressing means via a data network, and
the receiving and decompressing means having means for decompressing the message following its receipt after transmission and means for conveying the decompressed message to an addressee of the message,
wherein the predictive text entry means is arranged to suggest character strings derived from a messages corpus comprising messages upon which the compressing means and decompressing means base the compression and decompression, respectively.

2. (canceled)

3. (canceled)

4. (canceled)

5. (canceled)

6. (canceled)

7. (canceled)

8. (canceled)

9. (canceled)

10. (canceled)

11. (canceled)

12. A text messaging system according to claim 1, wherein said composing, compressing and transmitting means resides on a first messaging device equipped for communicating via said data network and said receiving and decompressing means resides on a second messaging device also equipped for communicating via said data network, the second messaging device further comprises means for composing, compressing and transmitting messages to said first messaging device via said data network, and said first messaging device further comprises means for receiving and decompressing said messages from the second messaging device.

13. A text messaging system according to claim 2, further comprising routing means for receiving a message from either of the first and second messaging means, decompressing the message, forwarding a copy of the decompressed message to a predetermined e-mail account, and recompressing the messages and forwarding the recompressed messages to the other of the first and second messaging devices.

14. (canceled)

15. A text messaging system according to claim 1, wherein the data network comprises a narrowband communications network.

16. (canceled)

17. A text messaging system according to claim 1, wherein the means for composing, compressing and transmitting messages and the means for receiving and decompressing those messages each comprise means for adding new messages to the respective messages corpus.

18. (canceled)

19. A text messaging system according to claim 1, wherein said corpus comprises an adaptive corpus section and a static corpus section, the new messages being added to the adaptive corpus section and the static corpus section comprising only predefined messages which are not changed during normal operation.

20. (canceled)

21. (canceled)

22. A text messaging system according to claim 19, wherein the means for composing, compressing and transmitting messages and the means for receiving and decompressing those messages comprise respective static messages corpora that comprise the same set of predefined messages that are not changed dynamically during normal operation, and said static messages corpora each comprise a plurality of corpus sections, the messages in each section of a particular corpus differing from the messages in the or each other section of the same corpus but being the same as the messages in the corresponding section of the other corpus, and wherein the composing, compressing and transmitting means further comprises means for selecting one of said corpus sections for use in composing and compressing the message and including in the message an identifier for the selected corpus section, and the receiving and decompressing means further comprises means for detecting the corpus section identified and selecting the corresponding corpus section for use in decompressing the message.

23. (canceled)

24. (canceled)

25. (canceled)

26. A text messaging method using means for composing, compressing and transmitting messages via a data network and means for receiving and decompressing said messages, the method comprising the steps of:
(i) at the composing, compressing and transmitting means, composing a message (MSG) using predictive text entry, compressing the composed message (MSG) and transmitting the compressed message via the data network, and
(ii) at the receiving and decompressing means, decompressing the received message (MSG) and conveying the decompressed message to an addressee of the message,
wherein, during the predictive text entry step, character strings suggested to the person composing the message are derived from a messages corpus upon which were based the steps of compression before transmission and decompression following transmission.

27. (canceled)

28. (canceled)

29. (canceled)

30. (canceled)

31. (canceled)

32. (canceled)

33. (canceled)

34. (canceled)

35. (canceled)

36. (canceled)

37. A text messaging method according to claim 26, wherein said composing, compressing and transmitting steps are performed by a first messaging device equipped for communicating via said data network and said receiving and decompressing steps are performed on a second messaging device also equipped for communicating via said data network, and the method further comprises the steps, at the second messaging device, of composing, compressing and transmitting messages to said first messaging device via said data network, and the further steps, at said first messaging device, of receiving and decompressing said messages from the second messaging device.

38. A text messaging method according to claim 37, further comprising, at a routing means, the steps of receiving messages from each of the first and second messaging means, decompressing the messages, forwarding a copy of the decompressed message to a predetermined e-mail account, and recompressing the messages and forwarding the recompressed messages to the other of the first and second messaging devices.

39. (canceled)

40. A text messaging method according to claim 26, wherein the messages are transmitted via a narrowband communications network.

41. (canceled)

42. A text messaging method according to claim 26, further comprising, at each of the means for composing, compressing and transmitting messages and the means for receiving and decompressing those messages, the step of adding new messages to the respective messages corpus.

43. (canceled)

44. A text messaging method according to claim 42, wherein each corpus comprises an adaptive corpus section and a static corpus section, and the method comprises the step of adding the new messages to the adaptive corpus section, the static corpus section comprising only predefined messages which are not changed during normal operation.

45. (canceled)

46. (canceled)

47. A text messaging method according to claim 26, wherein the means for composing, compressing and transmitting messages and the means for receiving and decompressing those messages comprise respective static messages corpora that comprise the same set of predefined messages that are not changed dynamically during normal operation, and said static messages corpora each comprise a plurality of corpus sections, the messages in each section of a particular corpus differing from the messages in the or each other section of the same corpus but being the same as the messages in the corresponding section of the other corpus, and wherein the step of composing, compressing and transmitting messages further comprises the steps of selecting one of said corpus sections for use in composing and compressing the message and including in the message an identifier for the selected corpus section, and the step of receiving and decompressing the message further comprises the step of detecting the corpus section identified and selecting the corresponding corpus section for use in decompressing the message.

48. (canceled)

49. (canceled)

50. (canceled)

51. A text messaging device comprising means for composing and compressing text messages and transmitting the compressed messages via a data network to means for receiving and decompressing the compressed text messages,
the composing, compressing and transmitting means having means for predictive text entry during composition of a message (MSG) in conjunction with means for compressing the composed message (MSG) and transmitting the compressed message to the receiving and decompressing means via the data network,
wherein the predictive text entry means is arranged to suggest character strings derived from a messages corpus comprising messages upon which the compressing means and decompressing means base the compression and decompression, respectively.

52. A text messaging method for a system employing means for composing, compressing and transmitting messages via a data network and means for receiving and decompressing said messages, the method comprising the steps of:
(i) at the composing, compressing and transmitting means, composing a message (MSG) using predictive text entry, compressing the composed message (MSG) and transmitting the compressed message via the data network;
wherein, during the predictive text entry step, character strings suggested to the person composing the message are derived from a messages corpus upon which were based the steps of compression before transmission and decompression following transmission.

53. A messaging hub means for use in a text messaging system or method, the messaging hub means comprising means responsive to user input for composing, compressing and transmitting text messages and means for receiving and decompressing similarly compressed text messages,
the composing, compressing and transmitting means having means for predictive text entry during composition of a message (MSG) in conjunction with means for compressing the composed message (MSG) and transmitting the compressed message to the receiving and decompressing means via a data network, and
the receiving and decompressing means having means for decompressing the message following its receipt after transmission and means for conveying the decompressed message to an addressee of the message,
wherein the predictive text entry means is arranged to suggest character strings derived from a messages corpus comprising messages upon which the compressing means and the decompressing means base the compression and the decompression, respectively.

54. (canceled)

55. (canceled)

56. (canceled)

57. A text messaging system according to claim 1, wherein the messages corpus comprising a natural language messages corpus and the suggestible character strings comprise words and phrases that are extracted from the natural language messages corpus by lexical and/or semantic searching.

58. A text messaging method according to claim 26, wherein the messages corpus comprises a natural language messages corpus and the suggestible character strings comprise words and phrases and are extracted from the natural language messages corpus by lexical and/or semantic searching.

59. (canceled)

60. (canceled)

61. (canceled)

62. (canceled)

63. A text messaging hub according to claim 53, wherein the means responsive to user input comprises a message handler for interfacing with a user-operated e-mail or Internet access device.

64. A text messaging method using a messaging hub having means responsive to user input for composing, compressing and transmitting messages via a data network and means for receiving and decompressing said messages, the method comprising the steps of:
(i) at the composing, compressing and transmitting means, receiving input from a user and in response thereto composing a message (MSG) using predictive text entry, compressing the composed message (MSG) and transmitting the compressed message via the data network, and
(ii) at the receiving and decompressing means, decompressing the received message (MSG) and conveying the decompressed message to an addressee of the message,
wherein, during the predictive text entry step, character strings suggested to the person composing the message are derived from a messages corpus upon which were based the steps of compression before transmission and decompression following transmission.

64. A method according to claim 63, wherein the user input is received from a user-operated e-mail or Internet access device.
